(19) United States
(12) Patent Application Publication
(10) Pub. No.: US 2002/0105022 A1
(43) Pub. Date: Aug. 8, 2002

(54) Monolithic semiconducting ceramic electronic component

(75) Inventors: Mitsutoshi Kawamoto, Hirakata-shi (JP); Hideaki Niimi, Hikone-shi (JP); Masahiro Kodama, Shiga-ken (JP); Atsushi Kishimoto, Kusatsu-shi (JP)

Correspondence Address: Keating & Bennett LLP, Suite 312, 10400 Eaton Place, Fairfax, VA, 22030, US

(73) Assignee: Murata Manufacturing Co., Ltd, Nagaokakyo-shi (JP)

(21) Appl. No.: 09/734,155

(22) Filed: Dec. 11, 2000

(30) Foreign Application Priority Data
Dec. 10, 2000 (JP) 11-351392

(51) Int. Cl. H01G 4/005

(52) U.S. Cl. 257/303; 361/303

(57) ABSTRACT

A monolithic semiconducting electronic component includes barium titanate-based semiconducting ceramic layers and internal electrode layers, which are alternately laminated, and external electrodes arranged to be electrically connected to the internal electrode layers. The ratio S/I of the thickness S of each of the semiconducting ceramic layers to the thickness I of each of the internal electrode layers is about 10 to about 50. Preferably, the internal electrode layers are composed of a nickel-based metal.

### BACKGROUND OF THE INVENTION

1. Field of the Invention

The present invention relates to monolithic semiconducting ceramic electronic components, and in particular, the present invention relates to a monolithic semiconducting ceramic electronic component having barium titanate as a major constituent and having a positive temperature coefficient of resistance.

2. Description of the Related Art

Barium titanate-based semiconducting ceramics have positive resistance temperature characteristics (PTC characteristics) in which the resistivity is low at room temperature and the resistance abruptly increases at a temperature higher than a certain temperature known as the Curie Point, and have been widely used to achieve temperature control, overcurrent protection, and isothermal heating. A decrease in room temperature resistance is desired in electronic components for overcurrent protection of circuits. In particular, in Universal Serial Bus (USB) computer peripheral equipment, small semiconducting ceramic electronic components having low resistivity and high withstand voltage are in high demand.

In response to such demands, a monolithic semiconducting ceramic electronic component is disclosed in a laid-open Japanese Patent Application No. 57-60802, in which semiconducting ceramic layers having barium titanate as a major constituent and internal electrode layers composed of a Pt-Pd alloy are alternately laminated and integrally fired. By constructing such a laminated structure, the electrode area in the semiconducting ceramic electronic component is increased, and the size of the electronic component itself is reduced.

A monolithic semiconducting ceramic electronic component is also disclosed in a laid-open Japanese Patent Application No. 6-151103, in which a Ni-based metal, instead of the Pt-Pd alloy, is used as a material for internal electrodes.

However, the monolithic semiconducting ceramic electronic component disclosed in JP 57-60802 exhibits relatively high resistance at room temperature because of small ohmic contact between the internal electrode layers and the semiconducting ceramic layers.

On the other hand, in accordance with the monolithic semiconducting ceramic electronic component disclosed in JP 6-151103, the material for internal electrodes includes Ni-based metal oxidizes fired in air, and therefore, after being fired in a reducing atmosphere, the material must be subjected to reoxidation treatment at a temperature which does not oxidize the Ni-based metal.

The resultant ceramic exhibits low resistance at room temperature since ohmic contact between the semiconducting ceramic layers and the internal electrode layers is obtained.

However, since the reoxidation treatment at low temperatures is required to prevent the Ni-based metal from oxidizing, the range of resistivity variation is about 10% or less.

### SUMMARY OF THE INVENTION

To overcome the above-described problems, preferred embodiments of the present invention provide a monolithic semiconducting electronic component having a greatly reduced size, the room temperature resistance is decreased to about 0.2 Ω or less, the range of resistivity variation is about 100% or more, and the withstand voltage is increased to about 20 V or more.

In accordance with preferred embodiments of the present invention, a monolithic semiconducting electronic component includes barium titanate-based semiconducting ceramic layers and internal electrode layers, which are alternately laminated, and external electrodes that are arranged to be electrically connected to the internal electrode layers. The ratio S/I of the thickness S of each of the semiconducting ceramic layers to the thickness I of each of the internal electrode layers is preferably about 10 to about 50.

The thickness S of the semiconducting ceramic layer corresponds to a distance between two adjacent internal electrode layers.

In the monolithic semiconducting ceramic electronic component of various preferred embodiments of the present invention, preferably, the internal electrode layers are preferably made of a nickel-based metal.

In accordance with the monolithic semiconducting ceramic electronic component of various preferred embodiments of the present invention having a structure as described above, it is possible to provide a monolithic semiconducting electronic component in which the size of the electronic component is greatly reduced, the room temperature resistance is decreased, the range of resistivity variation is increased, and the withstand voltage is increased. That is, by setting the ratio S/I of the thickness S of the semiconducting ceramic layer to the thickness I of the internal electrode layer at about 10 to about 50, it is possible to decrease the room temperature resistance and to increase the range of resistivity variation. The withstand voltage is thereby increased.

Further elements, characteristics, features, and advantages of the present invention will be apparent from the following description of the preferred embodiments with reference to the attached drawing.

### BRIEF DESCRIPTION OF THE DRAWING

FIG. 1 is a schematic diagram showing an example of a monolithic semiconducting ceramic electronic component in accordance with preferred embodiments of the present invention.

### DETAILED DESCRIPTION OF PREFERRED EMBODIMENTS

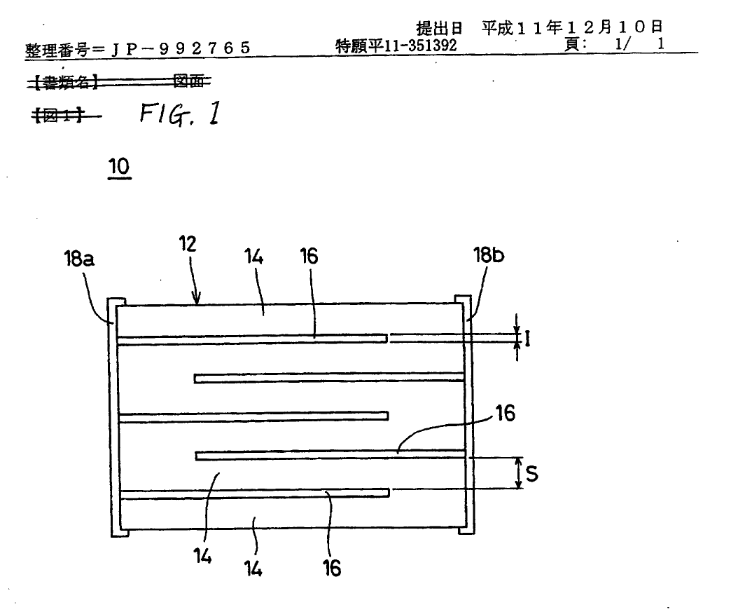

A monolithic semiconducting ceramic electronic component 10 shown in FIG. 1 includes a laminate 12. In the laminate 12, semiconducting ceramic layers 14 and internal electrode layers 16 are alternately laminated. In such a case, the ratio S/I of the thickness S of each of the semiconducting ceramic layers 14 to the thickness I of each of the internal electrode layers 16 is preferably about 10 to about 50. The ends of the individual internal electrode layers 16 alternately extend to one side and the other side of the laminate 12. Furthermore, an external electrode 18a and an external electrode 18b are provided on opposite sides of the laminate 12. In such a case, the external electrode 18a is connected to every other internal electrode layer 16, and the other external electrode 18b is connected to the remaining internal electrode layers 16.

The semiconducting ceramic layers 14 are preferably made of a semiconductor material having barium titanate as a major constituent, in which, Ba may be partially substituted by Ca, Sr, Pb, or other suitable material, and Ti may be partially substituted by Sn, Zr, or other suitable material. As a dopant for imparting semiconductive characteristics to the semiconducting ceramic layers 14, a rare-earth element, such as La, Y, Sm, Ce, Dy, or Gd, or a transition element, such as Nb, Ta, Bi, Sb, or W, is used. In addition, an oxide or a compound including Si, Mn, or other suitable material, may be added to the semiconducting ceramic layers 14, as required.

In the present invention, there are no limitations on the method for synthesizing barium titanate powder. For example, a sol-gel process, hydrothermal synthesis, a coprecipitation method, hydrolysis, or solid-phase synthesis, or other process, may be used. However, preferably, the particle size of the resulting barium titanate powder is about 1 μm or less, and the BaCO₃/BaO ratio observed by XPS is about 0.42 or less.

In the present invention, although there are no limitations on the ceramic particle size of the semiconducting ceramic layers 14, in view of the withstand voltage, the average ceramic particle size is preferably about 2 μm or less.

Although the thickness S of the semiconducting ceramic layer 14 is adjusted to the required room temperature resistance, to obtain a small, low-resistance monolithic semiconducting ceramic electronic component, the thickness S is preferably about 100 μm or less.

The internal electrode layers 16 may be constructed of a Ni-based metal, a Mo-based metal, a Cr-based metal, or an alloy thereof. In view of the reliability of ohmic contact with the semiconducting ceramic layers 14, the Ni-based metal is preferably used.

As a material for the external electrodes 18a and 18b, although Ag, Pd, or an alloy thereof may be used, the material is not limited thereto.

Next, the present invention will be described in more detail based on examples of preferred embodiments thereof. EXAMPLE 1

First, 15.40 l of 0.2 mol/l barium hydroxide solution (containing 3.079 mol of Ba) and 7.58 l of 0.35 mol/l Ti alkoxide solution (containing 2.655 mol of Ti) were prepared in separate vessels. In the Ti alkoxide solution, Ti(O—Pr)₄ (titanium tetraisopropoxide) was dissolved in isopropyl alcohol (IPA). Furthermore, 100 cc of lanthanum chloride dissolved in ethanol (containing 0.00664 mol of La) was homogeneously mixed into the Ti alkoxide solution.

The solutions in the individual vessels were then mixed with a static mixer to cause reaction, and the resulting solution was placed in a maturing vessel for 3 hours. Next, dehydration and cleaning were performed, followed by drying at 110° C. for 3 hours. Pulverization was then performed to obtain fine barium titanate powder containing La. The fine barium titanate powder containing La had a Ba/Ti ratio of 0.993 and an La/Ti ratio of 0.0021.

Next, the fine barium titanate powder was calcined at 1,100° C. for 2 hours, and an organic solvent, an organic binder, and a plasticizer were added thereto to produce a slurry. The slurry was molded by a doctor blade process, and green sheets were obtained. By screen-printing an Ni electrode paste on the green sheets, internal electrode layers were produced. The green sheets were laminated so that the internal electrode layers were alternately exposed, and pressure bonding was performed, followed by cutting to produce a laminate. Additionally, a dummy green sheet, on which an internal electrode layer was not printed, was provided and was pressure-bonded over each of the upper and lower surfaces of the laminate.

The laminate was then subjected to binder removal treatment in air, and firing was performed in a strong reducing atmosphere with a hydrogen/nitrogen ratio of 3/100 for 2 hours. After the firing, reoxidation treatment was performed in air at 600 to 1,000° C. for 1 hour. Ohmic silver paste was then applied, followed by baking in air to form external electrodes, and thus a monolithic semiconducting ceramic electronic component was obtained.

In the monolithic semiconducting ceramic electronic components, the thickness of the applied Ni electrode paste for forming internal electrode layers and the thickness of green sheets for forming semiconducting ceramic layers were set to various values. Furthermore, the number of semiconducting ceramic layers to be laminated was changed to various values to adjust the room temperature resistance.

The thickness S of the semiconducting ceramic layer and the thickness I of the internal electrode layer in each of the monolithic semiconducting ceramic electronic components obtained as described above were observed with an SEM by selecting any 10 spots of a cross section of each monolithic semiconducting ceramic electronic component, and an average value was determined. Thus, the ratio S/I of the thickness S of the semiconducting ceramic layer to the thickness I of the internal electrode layer was calculated. The room temperature resistance, the range of resistivity variation, and the withstand voltage were also measured with respect to the monolithic semiconducting ceramic electronic components obtained as described above. The room temperature resistance was measured, using a digital voltmeter, by a four-terminal method. The range of resistivity variation (in units) was calculated by dividing the maximum resistance by the room temperature resistance in the range from room temperature to 250° C. and using the common logarithm thereof. The withstand voltage was set as the maximum applied voltage immediately before the breakdown of the element. The results thereof are shown in Table 1 under Sample Nos. 1 to 5. Additionally, the asterisks in the table indicate that a sample is out of the ranges of various preferred embodiments of the present invention.

TABLE 1

| | Semiconducting | | | |
|---|---|---|---|---|
| | Ceramic layer | | | |
| | Thickness S/ | | | |
| | Internal | Room | Range of | |
| | Electrode | Temperature | Resistivity | Withstand |
| Sample | Layer | Resistance | Variation | Voltage |
| No | Thickness I | (Ω) | (unit) | (v) |
| 1 | 8 | 1.0 | 1.5 | 5 |
| 2 | 10 | 0.18 | 3.0 | 20 |
| 3 | 33 | 0.11 | 3.8 | 30 |
| 4 | 50 | 0.12 | 3.9 | 32 |
| 5 | 72 | 0.14 | 2.8 | 16 |
| 6 | 6 | 2.0 | 1.0 | 7 |
| 7 | 10 | 0.19 | 3.1 | 21 |
| 8 | 21 | 0.15 | 3.6 | 35 |
| 9 | 50 | 0.10 | 3.9 | 31 |
| 10 | 65 | 0.11 | 2.9 | 14 |

### EXAMPLE 2

As starting materials, BaCO₃, TiO₂, and a samarium nitrate solution were weighed so as to satisfy the molar ratios, Ba/Ti=1.002 and Sm/Ti=0.002. Mixing was then performed for 5 hours, using deionized water and PSZ balls having a diameter of 5 mm in a ball mill. Next, vaporization and drying were performed, and the resulting powder was calcined at 1,150° C. for 2 hours. After an organic solvent, an organic binder, a plasticizer, etc., were added to the calcined powder to form a slurry, the slurry was molded by a doctor blade process to obtain green sheets. The fabrication of monolithic semiconducting electronic components and the evaluation thereof were performed in the same manner as that in the first example. The results obtained in the second example are shown in Table 1 under Samples Nos. 6 to 10. Additionally, the asterisks in the table indicate that a sample is out of the ranges of preferred embodiments of the present invention.

As is obvious from Samples Nos. 1 and 6 in Table 1, when the ratio S/I of the thickness S of the semiconducting ceramic layer to the thickness I of the internal electrode layer is less than about 10, the room temperature resistance is increased, the range of resistivity variation is decreased, and the withstand voltage is decreased. As is obvious from Samples Nos. 5 and 10 in Table 1, when the ratio S/I exceeds about 50, the range of resistivity variation is less than about 3.0 units, and the withstand voltage is lower than about 20 V.

As described above, in accordance with preferred embodiments of the present invention, it is possible to obtain a monolithic semiconducting electronic component in which the size of the electronic component itself is greatly reduced, the room temperature resistance is decreased to about 0.2 Ω or less, the range of resistivity variation is increased to about 3.0 units or more, and the withstand voltage is increased to about 20 V or more.

In the monolithic semiconducting electronic component of various preferred embodiments of the present invention, when internal electrode layers are made of a nickel-based metal, it is possible to reliably bring semiconducting ceramic layers and the internal electrode layers into ohmic contact with each other, thus increasing the range of resistivity variation while avoiding an increase in the room temperature resistance.

While the preferred embodiments have been described, it is to be understood that modifications will be apparent to those skilled in the art without departing from the scope of the invention, which is to be determined solely by the following claims.

What is claimed is:

1. A monolithic semiconducting electronic component comprising:
barium titanate-based semiconducting ceramic layers;
internal electrode layers arranged such that the semiconducting ceramic layers and the internal electrode layers are alternately laminated to define a laminate body; and
external electrodes electrically connected to the internal electrode layers;
wherein a ratio S/I of the thickness S of each of the semiconducting ceramic layers to the thickness I of each of the internal electrode layers is about 10 to about 50.

2. A monolithic semiconducting electronic component according to claim 1, wherein the internal electrode layers comprise a nickel-based metal.

3. A monolithic semiconducting electronic component according to claim 1, wherein the external electrodes are provided on both sides of said laminate body.

4. A monolithic semiconducting electronic component according to claim 1, wherein said semiconducting ceramic layers include a dopant for imparting semiconductive characteristics to said ceramic layers.

5. A monolithic semiconducting ceramic component according to claim 4, wherein said dopant is a rare-earth element.

6. A monolithic semiconducting ceramic component according to claim 5, wherein said rare-earth element is La.

7. A monolithic semiconducting ceramic component according to claim 5, wherein said rare-earth element is Y.

8. A monolithic semiconducting ceramic component according to claim 1, wherein said semiconducting ceramic layers include an oxide.

9. A monolithic semiconducting ceramic component according to claim 8, wherein said oxide includes Si or Mn.

10. A monolithic semiconducting ceramic component according to claim 1, wherein said semiconducting ceramic layers are composed of ceramic particles having an average ceramic particle size of about 2 μm or less.

11. A monolithic semiconducting ceramic component according to claim 1, wherein said internal electrodes are composed of a Mo-based metal.

12. A monolithic semiconducting ceramic component according to claim 1, wherein said internal electrodes are composed of a Cr-based metal.

13. A monolithic semiconducting ceramic component according to claim 1, wherein the room temperature resistance of the monolithic semiconducting ceramic component is about 0.2 Ω or less.

14. A monolithic semiconducting ceramic component according to claim 1, wherein the range of resistivity of the monolithic semiconducting ceramic component is about 3.0 units or more.

15. A monolithic semiconducting ceramic component according to claim 1, wherein the withstand voltage of the monolithic semiconducting ceramic component is about 20 V or more.

16. A monolithic semiconducting electronic component comprising:
barium titanate-based semiconducting ceramic layers;
internal electrode layers arranged such that the semiconducting ceramic layers and the internal electrode layers are alternately laminated to define a laminate body; and
external electrodes electrically connected to the internal electrode layers;
wherein a ratio S/I of the thickness S of each of the semiconducting ceramic layers to the thickness I of each of the internal electrode layers is about 10 to about 50, the room temperature resistance of the monolithic semiconducting ceramic component is about 0.2 Ω or less, the range of resistivity of the monolithic semiconducting ceramic component is about 3.0 units or more, and the withstand voltage of the monolithic semiconducting ceramic component is about 20 V or more.

17. A monolithic semiconducting electronic component according to claim 16, wherein the internal electrode layers comprise a nickel-based metal.

18. A monolithic semiconducting electronic component according to claim 16, wherein the external electrodes are provided on both sides of said laminate body.

19. A monolithic semiconducting electronic component according to claim 16, wherein said semiconducting ceramic layers include a dopant for imparting semiconductive characteristics to said ceramic layers.

20. A monolithic semiconducting ceramic component according to claim 16, wherein said semiconducting ceramic layers are composed of ceramic particles having an average ceramic particle size of about 2 μm or less.
